(19) United States
(12) Patent Application Publication
(10) Pub. No.: US 2020/0325359 A1
(43) Pub. Date: Oct. 15, 2020

(54) SILICONE LACQUER FOR COATING EARMOLD

(71) Applicants: Thomas VEIT, Muenster (DE); Emre CIVELEK, Bergkamen (DE)

(72) Inventors: Thomas VEIT, Muenster (DE); Emre CIVELEK, Bergkamen (DE)

(21) Appl. No.: 16/846,562

(22) Filed: Apr. 13, 2020

(30) Foreign Application Priority Data
Apr. 12, 2019 (DE) 102019109729.0

(51) Int. Cl. C09D 183/04; C09D 7/65; C09D 5/00

(52) U.S. Cl. CPC C09D 183/04; C09D 5/00; C09D 7/65

(57) ABSTRACT

A two-component, addition-crosslinking silicone, crosslinking at room temperature or with UV radiation consists essentially of:
0.1-70% by weight polyorganosiloxanes with at least two unsaturated groups in the molecule;
0.1-15% by weight polyorganosiloxanes with at least two SiH groups in the molecule;
0.1-10% by weight polyorganosiloxanes without reactive groups;
0.01-2.0% by weight of noble metal catalyst;
0.1-30% by weight reinforcing fillers, with loaded or unloaded surface; and
0.01-0.5% by weight of at least one antistatic additive.

### FIELD OF THE INVENTION

The present invention relates to a silicone. More particularly this invention concerns a silicone lacquer for surface treating polymerizable materials used in medical appliances, in particular hearing-aid earmolds, swimmer's earplugs, and dental appliances and based on polyorganosiloxanes.

### BACKGROUND OF THE INVENTION

Indirect as well as direct methods are currently used for the production of noise and float protection earmolds made of silicone. Since the requirements for comfort are very high, the shape and fitting of the silicone earmold is very important. Addition-crosslinking silicones that have only a slight shrinkage and are therefore particularly dimensionally stable have proven to be particularly suitable.

According to the state of the art, addition-crosslinking silicones consist of the following components (all or a combination of these components):

1) Polyorganosiloxanes with at least two unsaturated groups in the molecule (meaning vinyl groups);

2) Polyorganohydrogensiloxanes with at least two SiH groups in the molecule (without vinyl groups);

3) Polyorganosiloxanes without reactive groups (i.e. neither vinyl groups nor SIH groups);

4) Noble metal catalyst(s);

5) Reinforcing fillers with a loaded or unloaded surface;

6) Non-reinforcing fillers;

7) Oils or other plasticizers;

8) Further additives and usual additives, additives and dyes;

9) Inhibitors.

The compounds according to 1) are polyorganosiloxanes with terminal and/or pendant reactive groups with a viscosity at 23° C. of about 50 mPa·s to 165,000 mPa·s, preferably 200 mPa·s to 65,000 mPa·s.

The compounds according to 2) contain reactive SiH groups that build up the polymer in an addition reaction with noble metal catalysis with the compounds 1).

The compounds according to 3) include the silicone oils that, like the compounds according to 1), are polyorganosiloxanes but do not contain any reactive groups and are therefore not involved in the noble metal-catalyzed addition crosslinking reaction. Such compounds are for example described in W. Noll “Chemie and Technologie der Silikone,” Verlag Chemie Weinheim, 1968.

The noble metal catalyst 4) is preferably a platinum complex; platinum-siloxane complexes, as already described in U.S. Pat. Nos. 3,715,334, 3,775,352, and 3,814,730, are particularly suitable. UV-active platinum complexes, as already described in U.S. Pat. No. 4,530,879 and in U.S. Pat. No. 8,088,878, are particularly suitable for radiation-curing silicone compositions.

Reinforcing fillers according to 5) generally have a BET surface area of greater than 50 m²/g. These include, for example, pyrogenic or precipitated fumed silicas and mixed silicon aluminum oxides. The fillers mentioned can be made hydrophobic by surface treatment with, for example, hexamethyldisilazane or organosiloxanes, or organosilanes.

The non-reinforcing fillers according to 6) have a BET surface area of up to 50 m²/g. These include quartz, cristobalite, diatomaceous earth, kieselgurs, calcium carbonate, talc, zeolite, sodium aluminum silicate, metal oxide, and glass powder. These fillers, like the reinforcing fillers, can also be made hydrophobic by surface treatment.

The compounds according to 7) are, for example, hydrocarbons, paraffin oils and isoeicosanes being particularly preferred.

Color pigments and other additives such as, for example, finely divided platinum or palladium can also be present as additives as hydrogen absorbers. It may be necessary to use the inhibitors 9) to control the reactivity. Such inhibitors are known and are described, for example, in U.S. Pat. No. 3,933,880. As a rule, these are acetylenically unsaturated alcohols or poly-, oligo- and disiloxanes containing vinyl groups.

The compositions are preferably formulated in two components in order to ensure storage stability. The total content of noble metal catalysts 4) is contained in the first catalyst component; the total content of SiH compounds 2) is contained in the second component that is spatially separated from the first component. By mixing the two components, the compositions are cured in an addition reaction known as hydrosilylation. Depending on the choice of the noble metal catalysts 4) (UV-active or inactive) and the addition of the inhibitors (9), the reaction can be accelerated in time (with or without UV radiation) or slowed down.

The volume ratios of the two components can be 10:1 to 1:10. Volume mixing ratios of 1:1, 4:1, 5:1, and 10:1 (base to catalyst) are particularly preferred.

Silicone earmolds are partially coated with a lacquer as a surface finish according to the state of the art. Such a lacquer has the following composition:

1) Polyorganosiloxanes having at least two unsaturated groups in the molecule;

2) Polyorganohydrogensiloxanes having at least two SiH groups in the molecule;

3) Polyorganosiloxanes without reactive groups;

4) Noble metal catalyst(s);

5) Reinforcing fillers with a loaded or unloaded surface;

6) Inhibitors;

7) Organic solvents.

The points listed above apply to compounds 1) to 6). This lacquer is also a two-component material and the observations made also apply here. The organic solvents that are used according to the invention have a boiling point at 1013 hPa in the range from 40-200° C., preferably in the range from 70-170° C., particularly preferably in the range from 100-165° C. Cyclic and aliphatic hydrocarbons as well as molecules from the field of siloxanes come into question. Cyclohexane, n-hexane, n-heptane, toluene, gasoline, hexamethyldisiloxane, or octamethyltrisiloxane can be mentioned by way of example.

Silicone earmolds in the form of noise or swimming protection are usually worn in the ear for a long time. It is therefore important to pay special attention to hygiene. The use of silicones in the field of noise and swimming protection is well known, because the silicones offer a wide range of mechanical and physical properties and have the further advantage that they have little or no toxic, sensitizing or allergenic potential. This makes them very suitable for medical applications. The fitting of earmolds plays a special role. The earmold is in direct contact with the skin of the ear. The moist and warm environment in the ear canal offers ideal conditions for the growth of microorganisms (bacteria, viruses, fungi, algae) that are known to settle on silicones. This affects not only the hygiene, but also the aesthetics of earmolds that people wear over a long period of time for the purpose of noise protection, for example when practicing their profession or as protection when swimming. In particular, inflammation can occur if the skin of the ear canal is irritated by pressure points (due to bad fit of the earmold) or rubbing by chewing movements. Another important point regarding hygiene is the dust attraction of common silicones, which is a problem in everyday use.

Based on the points listed, the setting of an antistatic, biocompatible and mechanically resilient lacquer made of silicone in the form of a polymerization reaction (crosslinking at room temperature or crosslinking with UV radiation) is desirable.

Antistatic silicones have been known for many years. They are used as a separating film on semiconductor, electronic, and display devices that can cause problems with static electricity. Examples of this have been described by Toray Saehan Inc. in U.S. Pat. No. 9,988,560 that obtain the antistatic properties by polymerizing polythiophenes or derivatives and by Shin-Etsu Polymer Co. Ltd. in U.S. Pat. No. 9,624,398 that contains at least one amine-like compound selected from the group consisting of a secondary amine, a tertiary amine, or a quaternary ammonium salt having a counter anion. Further silicones with antistatic properties that are produced by adding conductive additives, were developed by Shin-Etsu by adding molecules with epoxy and vinyl units in U.S. Pat. No. 10,179,868, by using different lithium salts in US 2008/0260981 and by using secondary and tertiary amines or quaternary ammonium salts that are positively charged and contain a counter anion (so-called ionic liquids) described in U.S. Pat. No. 9,624,398. Antimicrobial antistatic products were also described over 20 years ago by Dow Corning Toray Co. Ltd. in EP 0233954.

However, all of the additives mentioned and published with antistatic properties do not meet the high requirements that must be placed on polymerizable materials that are worn in the ear over a long period of time, such as noise and floating protection earmolds:
The antistatic additive must not be toxic and have no sensitizing or allergenic potential or must not be toxic within the entire compositions and have no sensitizing or allergenic potential.
The polymerizable composition should contain the antistatic additive in a sufficient quantity to be able to exert its effect on the surface of the material.
The antistatic additive must not inhibit the polymerization reaction and must not change the typical properties of the polymer.

The object of the invention is therefore to provide a material for earmolds, especially for noise and swimming protection, which has biocompatible and antistatic properties, is at the same time highly resilient, and does not present the negative properties mentioned.

This object is achieved by using the correct concentration of one or more antistatic additives and the associated silicone composition. While the antistatic additive is responsible for the antistatic properties, the right silicone composition represents the mechanically highly resilient properties. The correct concentration of the antistatic additive helps to ensure that the silicone is biocompatible and that the antistatic properties are sufficiently good for use.

The object of the present invention is also to provide a corresponding silicone-based lacquer. This goal is achieved in the same way by using one or more antistatic additives in the lacquer. This antistatic lacquer for the surface treatment of silicones should be applicable both by classic brush and immersion methods and by spraying methods (manually using airbrush technology or mechanically with, for example, the automatic painting system DACS from Dreve Otoplastik GmbH). The invention solves the problem by the composition and use specified in the claims.

In this context, it is important to have a reliable and reproducible method of measuring the antistatic properties of plastic surfaces in general, but especially of silicone surfaces.

The safest indicator for the antistatic property of plastic surfaces in general, but especially of silicone surfaces, is the surface resistance that is directly related to the conductivity, since the current charge of the plastics material/silicone does not falsify the measurement result. The surface resistance allows direct conclusions to be drawn about the chargeability and thus also the tendency of the plastics material/silicone to attract dust particles (from the operating instructions of the MECO antistatic tester MGT-4).

Surprisingly, it has been found that polymerizable compositions, in particular those based on polyorganosiloxanes, can be adjusted antistatically by adding one or more antistatic additives, and the substantial properties of the compositions remain unaffected by the addition:

unchanged storage stability,

unchanged processing and curing times,

unchanged hardness,

unchanged viscosities,

unchanged processability.

The surface condition remains unchanged. However, the surface has antistatic properties, which means that dust and dirt particles are not attracted and clearly deposit less on the surface. Dust particles attached to the surface can be easily removed by blowing or brushing away. In comparison, silicone compositions without antistatic properties clearly attract more dust, as is known for silicone. These cannot be easily removed by blowing or swiping them away.

The antistatic additives are polyether-modified siloxanes, such as are available from Gelest and Evonik Industries AG and Momentive, for example. The products MCS-E15, MCR-E21 and MCR-E11 (propyl ether modified siloxanes) from Gelest and the TEGOPREN products TEGOPREN 5803, TEGOPREN 5840, TEGOPREN 5852, TEGOPREN 5857, TEGOPREN 5863, TEGOPREN 5864, TEGOPREN 5884, TEGOPREN 5884-35 from Evonik Industries AG are to be mentioned by way of example. Also noteworthy are the Silwet products from Momentive L-77 and L-7280. The antistatic effects of these additives are known to the person skilled in the art and can be found in the relevant literature. The concentration of these additives is particularly important. The higher the addition of trisiloxane, the stronger the antistatic effect in the silicone composition.

The polyether-modified siloxanes are preferably and in particular surface-active trisiloxanes with a hydrophobic siloxane component (30-50% by weight) and a hydrophilic component made from ethylene and/or propylene oxide (50-70% by weight).

The polyether siloxanes mentioned are surface-active trisiloxanes. These are small, therefore very mobile molecules. They interact twice and are necessary for the antistatic effect:

Interaction of the hydrophobic siloxane component with the basic mixture used that is composed of vinyl-functional polydimethylsiloxanes and special fillers. This allows the incorporation of the polyether siloxane into the silicone matrix of the silicone lacquer without thickening (increase in viscosity) at the selected concentration. This would be unfavorable for use as a lacquer.

Interaction of the hydrophilic component (ethylene and/or propylene oxide components) with the moisture in the air, as a result of which the silicone surface is moistened and thus conductive. Charges can drain off more easily and the surface becomes antistatic. The surface coated in this way can neither build up nor hold electrical charge.

The following embodiments serve to describe the invention in more detail, they are very detailed and are not intended to limit the invention in any way.

### EXAMPLE 1

### Transparent Silicone Material (Comparative Example)

Catalyst component

1.9% by weight vinyl-terminated polydimethylsiloxane with a viscosity of 200 mPa·s

1.9% by weight vinyl-terminated polydimethylsiloxane with a viscosity of 1,000 mPa·s

2.8% by weight vinyl-terminated polydimethylsiloxane with a viscosity of 10,000 mPa·s

50.4% by weight vinyl-terminated polydimethylsiloxane with a viscosity of 65,000 mPa·s

8.9% by weight of a polydimethylsiloxane oil with a viscosity of 50 mPa·s

12.0% by weight of a paraffin oil

21.7% by weight of a fumed silica (surface treated) with a BET surface area between 150 and 200 m²/g.

0.4% by weight of a platinum catalyst

are provided and mixed homogeneously for 30 minutes. The mixture is then degassed in vacuo for 15 minutes.

Basic component

1.9% by weight vinyl-terminated polydimethylsiloxane

with a viscosity of 200 mPa·s

1.9% by weight vinyl-terminated polydimethylsiloxane with a viscosity of 1,000 mPa·s

2.9% by weight vinyl-terminated polydimethylsiloxane with a viscosity of 10,000 mPa·s

49.6% by weight vinyl-terminated polydimethylsiloxane with a viscosity of 65,000 mPa·s

3.1% by weight of a polydimethylsiloxane oil with a viscosity of 50 mPa·s

7.6% by weight of a paraffin oil

21.2% by weight of a fumed silica (surface treated) with a BET surface area between 150 and 200 m²/g

11.8% by weight of a polymethylhydrogensiloxane with an SiH content of 2.3 mmol/g

are provided and mixed homogeneously for 30 minutes. The mixture is then degassed in vacuo for 15 minutes.

Mixture of catalyst and base components

50 parts catalyst component and 50 parts base component are conveyed from a double cartridge and mixed homogeneously using a static mixer. A cured test specimen with a final hardness of 40 Shore A and excellent mechanical properties (tensile strength, elongation at break) is obtained. Surface resistance: >1*1012? (not antistatic).

### EXAMPLE 2

### Transparent Silicone Lacquer (Comparative Example)

Catalyst component

67.6% by weight of hexamethyldisiloxane with a viscosity of 0.5 mPa·s

13.5% by weight of a polydimethylsiloxane oil with a viscosity of 10 mPa·s

18.9% by weight of a platinum catalyst

are provided and mixed homogeneously for 30 minutes.

Basic component

9.0% by weight vinyl-terminated polydimethylsiloxane with a viscosity of 200 mPa·s

3.4% by weight vinyl-terminated polydimethylsiloxane with a viscosity of 1,000 mPa·s

4.9% by weight vinyl-terminated polydimethylsiloxane resin with a viscosity of 1,000 mPa·s

15.5% by weight vinyl-terminated polydimethylsiloxane with a viscosity of 10,000 mPa·s

40.8% by weight of hexamethyldisiloxane with a viscosity of 0.5 mPa·s

15.9% by weight of a polydimethylsiloxane oil with a viscosity of 10 mPa·s

6.6% by weight of a fumed silica (surface treated) with a BET surface area between 150 and 200 m²/g

3.9% by weight of a polymethylhydrogensiloxane with an SiH content of 7.3 mmol/g are provided and mixed homogeneously for 30 minutes.

Mixture of catalyst and base components

1 part catalyst component and 10 parts base component are mixed homogeneously using a static mixer. A hardened test specimen with a final hardness of 25 Shore A is obtained. The mechanical properties are inadequate and cannot be clearly demonstrated. Surface resistance: >1*1012? (not antistatic).

### EXAMPLE 3

### Transparent Silicone Material (According to the Invention)

Catalyst component

2.0% by weight vinyl-terminated polydimethylsiloxane with a viscosity of 200 mPa·s

2.0% by weight vinyl-terminated polydimethylsiloxane with a viscosity of 1,000 mPa·s

2.6% by weight vinyl-terminated polydimethylsiloxane with a viscosity of 10,000 mPa·s

50.4% by weight vinyl-terminated polydimethylsiloxane with a viscosity of 65,000 mPa·s

8.9% by weight of a polydimethylsiloxane oil with a viscosity of 50 mPa·s

11.9% by weight of a paraffin oil

21.7% by weight of a fumed silica (surface treated) with a BET surface area between 150 and 200 m²/g

0.4% by weight of a platinum catalyst

0.1% by weight of polyether siloxane, namely trisiloxane

are provided and mixed homogeneously for 30 minutes. The mixture is then degassed in vacuo for 15 minutes.

Basic component

2.0% by weight vinyl-terminated polydimethylsiloxane with a viscosity of 200 mPa·s

2.0% by weight vinyl-terminated polydimethylsiloxane with a viscosity of 1,000 mPa·s

2.7% by weight vinyl-terminated polydimethylsiloxane with a viscosity of 10,000 mPa·s

49.6% by weight vinyl-terminated polydimethylsiloxane with a viscosity of 65,000 mPa·s

3.1% by weight of a polydimethylsiloxane oil with a viscosity of 50 mPa·s

7.5% by weight of a paraffin oil

21.2% by weight of a fumed silica (surface treated) with a BET surface area between 150 and 200 m²/g

11.8% by weight of a polymethylhydrogensiloxane with an SiH content of 2.3 mmol/g

0.1% by weight of polyether siloxane, namely trisiloxane

are provided and mixed homogeneously for 30 minutes. The mixture is then degassed in vacuo for 15 minutes.

Mixture of catalyst and base components

50 parts catalyst component and 50 parts base component are conveyed from a double cartridge and mixed homogeneously using a static mixer. A cured test specimen with a final hardness of 40 Shore A and excellent mechanical properties (tensile strength, elongation at break) is obtained. Surface tension: 5*10⁹Ω (antistatic).

### EXAMPLE 4

### Transparent Silicone Material (According to the Invention)

Catalyst component

3.0% by weight vinyl-terminated polydimethylsiloxane with a viscosity of 200 mPa·s

2.0% by weight vinyl-terminated polydimethylsiloxane with a viscosity of 1,000 mPa·s

1.6% by weight vinyl-terminated polydimethylsiloxane with a viscosity of 10,000 mPa·s

50.4% by weight vinyl-terminated polydimethylsiloxane with a viscosity of 65,000 mPa·s

8.9% by weight of a polydimethylsiloxane oil with a viscosity of 50 mPa·s

11.8% by weight of a paraffin oil

21.7% by weight of a fumed silica (surface treated) with a BET surface area between 150 and 200 m²/g

0.4% by weight of a platinum catalyst

0.2% by weight of polyether siloxane, namely trisiloxane

are provided and mixed homogeneously for 30 minutes. The mixture is then degassed in vacuo for 15 minutes.

Basic component

2.0% by weight vinyl-terminated polydimethylsiloxane with a viscosity of 200 mPa·s

2.0% by weight vinyl-terminated polydimethylsiloxane with a viscosity of 1,000 mPa·s

2.7% by weight vinyl-terminated polydimethylsiloxane with a viscosity of 10,000 mPa·s

49.6% by weight vinyl-terminated polydimethylsiloxane with a viscosity of 65,000 mPa·s

3.1% by weight of a polydimethylsiloxane oil with a viscosity of 50 mPa·s

7.4% by weight of a paraffin oil

21.2% by weight of a fumed silica (surface treated) with a BET surface area between 150 and 200 m²/g

11.8% by weight of a polymethylhydrogensiloxane with an SiH content of 2.3 mmol/g

0.2% by weight of polyether siloxane, namely trisiloxane

are provided and mixed homogeneously for 30 minutes. The mixture is then degassed in vacuo for 15 minutes.

Mixture of catalyst and base components

50 parts catalyst component and 50 parts base component are conveyed from a double cartridge and mixed homogeneously using a static mixer. A cured test specimen with a final hardness of 40 Shore A and excellent mechanical properties (tensile strength, elongation at break) is obtained. Surface tension: 2*10⁹Ω (antistatic).

### EXAMPLE 5

### Transparent Silicone Material (According to the Invention)

Catalyst component

3.0% by weight vinyl-terminated polydimethylsiloxane with a viscosity of 200 mPa·s

2.0% by weight vinyl-terminated polydimethylsiloxane with a viscosity of 1,000 mPa·s

1.6% by weight vinyl-terminated polydimethylsiloxane with a viscosity of 10,000 mPa·s

50.4% by weight vinyl-terminated polydimethylsiloxane with a viscosity of 65,000 mPa·s

9.0% by weight of a polydimethylsiloxane oil with a viscosity of 50 mPa·s

11.6% by weight of a paraffin oil

21.7% by weight of a fumed silica (surface treated) with a BET surface area between 150 and 200 m²/g

0.4% by weight of a platinum catalyst

0.3% by weight of polyether siloxane, namely trisiloxane

are provided and mixed homogeneously for 30 minutes. The mixture is then degassed in vacuo for 15 minutes.

Basic component

4.0% by weight vinyl-terminated polydimethylsiloxane with a viscosity of 200 mPa·s

2.7% by weight vinyl-terminated polydimethylsiloxane with a viscosity of 10,000 mPa·s

49.6% by weight vinyl-terminated polydimethylsiloxane with a viscosity of 65,000 mPa·s

3.1% by weight of a polydimethylsiloxane oil with a viscosity of 50 mPa·s

7.3% by weight of a paraffin oil

21.2% by weight of a fumed silica (surface treated) with a BET surface area between 150 and 200 m²/g

11.8% by weight of a polymethylhydrogensiloxane with an SiH content of 2.3 mmol/g

0.3% by weight of polyether siloxane, namely trisiloxane

are provided and mixed homogeneously for 30 minutes. The mixture is then degassed in vacuo for 15 minutes.

Mixture of catalyst and base components

50 parts catalyst component and 50 parts base component are conveyed from a double cartridge and mixed homogeneously using a static mixer. A cured test specimen with a final hardness of 40 Shore A and excellent mechanical properties (tensile strength, elongation at break) is obtained. Surface tension: 2*10⁹Ω (antistatic).

### EXAMPLE 6

### Transparent Silicone Lacquer (According to the Invention)

Catalyst component

67.6% by weight of hexamethyldisiloxane with a viscosity of 0.5 mPa·s

13.5% by weight of a polydimethylsiloxane oil with a viscosity of 10 mPa·s

18.9% by weight of a platinum catalyst

are provided and mixed homogeneously for 30 minutes.

Basic component

30.1% by weight of vinyl-terminated polydimethylsiloxane with a viscosity of 10,000 mPa·s

43.2% by weight hexamethyldisiloxane with a viscosity of 0.5 mPa·s

11.4% by weight of a polydimethylsiloxane oil with a viscosity of 10 mPa·s

13.0% by weight of a fumed silica (surface-treated) with a BET surface area between 150 and 200 m²/g

2.2% by weight of a polymethylhydrogensiloxane with an SiH content of 7.3 mmol/g

0.1% by weight of polyether siloxane, namely trisiloxane

are provided and mixed homogeneously for 30 minutes.

Mixture of catalyst and base components

1 part catalyst component and 10 parts base component are mixed homogeneously using a static mixer. A hardened test specimen with a final hardness of 25 Shore A is obtained. The mechanical properties are shown below: Elongation at break: 342%, tensile strength: 2.8 MPa, force at break: 18.4 N, tear resistance: 9.0 kN/m with a thickness of 2.9 mm. Surface tension: 5*10⁹Ω (antistatic).

### EXAMPLE 7

### Transparent Silicone Lacquer (According to the Invention)

Catalyst component

67.6% by weight of hexamethyldisiloxane with a viscosity of 0.5 mPa·s

13.5% by weight of a polydimethylsiloxane oil with a viscosity of 10 mPa·s

18.9% by weight of a platinum catalyst

are provided and mixed homogeneously for 30 minutes.

Basic component

30.1% by weight of vinyl-terminated polydimethylsiloxane with a viscosity of 10,000 mPa·s

43.2% by weight hexamethyldisiloxane with a viscosity of 0.5 mPa·s

11.3% by weight of a polydimethylsiloxane oil with a viscosity of 10 mPa·s

13.0% by weight of a fumed silica (surface-treated) with a BET surface area between 150 and 200 m²/g

2.2% by weight of a polymethylhydrogensiloxane with an SiH content of 7.3 mmol/g

0.2% by weight of polyether siloxane, namely trisiloxane

are provided and mixed homogeneously for 30 minutes.

Mixture of catalyst and base components

1 part catalyst component and 10 parts base component are mixed homogeneously using a static mixer. A hardened test specimen with a final hardness of 25 Shore A is obtained. The mechanical properties are shown below: Elongation at break: 340%, tensile strength: 2.7 MPa, force at break: 18.3 N, tear resistance: 9.0 kN/m with a thickness of 2.9 mm. Surface tension: 2*10⁹Ω (antistatic).

### EXAMPLE 8

### Transparent Silicone Lacquer (According to the Invention)

Catalyst component

67.6% by weight of hexamethyldisiloxane with a viscosity of 0.5 mPa·s

13.5% by weight of a polydimethylsiloxane oil with a viscosity of 10 mPa·s 18.9% by weight of a platinum catalyst

are provided and mixed homogeneously for 30 minutes.

Basic component

30.1% by weight of vinyl-terminated polydimethylsiloxane with a viscosity of 10,000 mPa·s

43.2% by weight hexamethyldisiloxane with a viscosity of 0.5 mPa·s 11.2% by weight of a polydimethylsiloxane oil with a viscosity of 10 mPa·s

13.0% by weight of a fumed silica (surface-treated) with a BET surface area between 150 and 200 m²/g

2.2% by weight of a polymethylhydrogensiloxane with an SiH content of 7.3 mmol/g

0.3% by weight of polyether siloxane, namely trisiloxane

are provided and mixed homogeneously for 30 minutes.

Mixture of catalyst and base components

1 part catalyst component and 10 parts base component are mixed homogeneously using a static mixer. A hardened test specimen with a final hardness of 25 Shore A is obtained. The mechanical properties are shown below: Elongation at break: 341%, tensile strength: 2.7 MPa, force at break: 18.4 N, tear resistance: 9.0 kN/m with a thickness of 2.9 mm. Surface tension: 2*10⁹Ω (antistatic)

We claim:

1. A two-component, addition-crosslinking silicone, crosslinking at room temperature or with UV radiation, consisting essentially of:
0.1-70% by weight polyorganosiloxanes with at least two unsaturated groups in the molecule;
0.1-15% by weight polyorganosiloxanes with at least two SiH groups in the molecule;
0.1-10% by weight polyorganosiloxanes without reactive groups;
0.01-2.0% by weight of noble metal catalyst;
0.1-30% by weight reinforcing fillers, with loaded or unloaded surface; and
0.01-0.5% by weight of at least one antistatic additive.

2. The silicone according to claim 1, further comprising:
up to 30% by weight oils or other plasticizers; or
up to 20% by weight non-reinforcing fillers; or
up to 1% by weight inhibitors.

3. The silicone according to claim 1, wherein the antistatic additive is a polyether siloxane or a combination of polyether siloxanes.

4. A silicone lacquer crosslinkable at room temperature and curing with UV radiation and for surface coating earmolds without their own antistatic properties, consisting of:
0.1-50% by weight polyorganosiloxanes with at least two unsaturated groups in the molecule;
0.1-15% by weight polyorganosiloxanes with at least two SiH groups in the molecule;
0.1-10% by weight polyorganosiloxanes without reactive groups;
0.01-2.0% by weight of noble metal catalyst (UV-active/inactive depending on the application);
0.1-30% by weight reinforcing fillers, with loaded or unloaded surface;
0.1-50% by weight organic solvents; and
at least 0.01-0.5% by weight of an antistatic additive.

5. The silicone lacquer according to claim 4, which additionally contains:
up to 30% by weight oils or other plasticizers or
up to 20% by weight non-reinforcing fillers or
up to 1% by weight inhibitors.

6. The silicone lacquer according to claim 4, wherein the antistatic additive is a polyether siloxane or a combination of polyether siloxanes.

7. The silicone lacquer according to any of claims 4 to 6, wherein the antistatic silicone lacquer can be used for the surface treatment of silicones both by brush and immersion processes and by spraying processes.
